(19) United States
(12) Patent Application Publication
(10) Pub. No.: US 2025/0391043 A1
(43) Pub. Date: Dec. 25, 2025

(54) Artificial Intelligence Based System and Method for Proximity Detection in Video Streams

(71) Applicant: Edge Signal Corporation, Kanata (CA)

(72) Inventors: Adem Burak CAKMAK, Kanata (CA); Steven PHAM, Kanata (CA)

(21) Appl. No.: 18/753,382

(22) Filed: Jun. 25, 2024

(51) Int. Cl. G06T 7/70; G06T 7/194; G06T 7/20; G06T 7/50; G06V 10/764; G06V 10/82; G06V 20/52

(52) U.S. Cl. CPC G06T 7/70; G06T 7/194; G06T 7/20; G06T 7/50; G06V 10/764; G06V 20/52; G06T 2207/10016; G06T 2207/20084; G06T 2207/30196; G06T 2207/30232; G06V 10/82

(57) ABSTRACT

To reduce the processing load of a computer vision system, a set of artificial intelligence based pre-processing subsystems identify objects of interest in motion and create data about those objects. The computer vision processing can then be directed to only considering the identified objects of interest, thus reducing the processing required. When two identified objects are determined to be within a threshold distance of each other, a close-proximity detection subsystem can generate an alert, or trigger an event in one or more systems.

### TECHNICAL FIELD

This application relates generally to a computer vision processing system, and more particularly to an artificial intelligence based system and method for proximity detection in video streams.

### BACKGROUND

In many environments, for example industrial or commercial environments, space is allocated for individual machines and objects. Additionally, it has been common to allocate space to allow human operators and other workers to move through a factory without coming too close to the machinery when in operation. Conventionally, a visual demarcation of these spaces is provided, for example in the form of yellow tape or paint on the floor indicating the space (including a safety buffer) allocated to machinery. Humans are able to use this visual indicator to denote areas in which they are able to traverse with what amounts to a right of way.

In some environments, objects, for example machinery itself, may be mobile. This mobility may be under the control of a human operator or it may be autonomously controlled movement. This creates a hazard condition in which mobile machinery may be in close proximity during movement through its environment with any one or more of other mobile machinery, static machinery, humans, and other static elements such as environmental infrastructure. This may result in a collision of the mobile object with another object and/or human worker. Any such collision may result in damage or injury that should be avoided for safe operation within the environment. In contrast, in some cases, it may be necessary to monitor intended close engagements between individuals and/or moving objects. This may include, for example, tracking close engagement of employees with clients. In these examples, close proximity is a desired outcome.

To avoid hazardous or desired close proximity, detection of mobile objects approaching something with which it may collide or engage is important. In some cases, this can be achieved through identifying situations in which mobile object comes within a threshold distance to another entity (e.g. the aforementioned elements with which the mobile object may collide). This threshold distance may be associated with the mobile machinery, with the other entity, and the pairing of the mobile object and the other entity. The threshold may also vary as a function of the speed at which the mobile object or machinery is traveling (either in absolute terms or relative to the other entity). For example, a threshold may be larger when the mobile object is traveling above a predefined speed, and smaller when the mobile object is traveling below a predefined speed. This can account for situations in which mobile object needs to approach infrastructure (for example to offload materials, or to pick up materials from a dispenser) and can do so safely at a low speed, but also account for an increased stopping distance for the mobile object when moving quickly.

In some solutions, determining that mobile object is too close to another element can be a process that is distributed into each element of mobile object and infrastructure within the industrial environment. Such a solution may make use of beacons or other such communications elements attached to each element of interest in the environment. The beacons can allow elements of interest to identify each other and make decisions about whether they are too close. However, this creates multiple points of failure and has a high deployment cost. While it may be found suitable in greenfield deployments, it is a high cost solution for deployment in existing environments.

A centralized solution making use of video and image processing to identify mobile object and other elements of interest within the environment can be used. A video feed is typically comprised of a series of images each representing the placement of elements of interest, including mobile object, with respect to each other within a field of view of the camera. Video feeds often have a fixed resolution (i.e. the size of each still image) and they also typically have fixed frame rates (the number of still image frames generated per second). It should be noted that many industrial environments already have video capture devices (e.g. surveillance cameras) that may be used for any of a number of different uses. Use of the video output of these devices allows for reuse of already deployed assets reducing the cost of deployment.

FIG. 1 illustrates an example of an industrial environment 50 in which an industrial floor 52 is shown. Within the industrial environment are static infrastructure elements 54, for example production lines. Moving “objects” including humans 56 and mobile machinery 58 are also present. In this exemplary illustrated embodiment the mobile machinery 58 is shown which may be autonomously controlled, or may be controlled by a human operator either directly or remotely. Pathways are marked out on the floor of the industrial facility 52 to indicate a region 60 in which humans 56 should restrict their movement, and in which humans may be afforded a right-of-way. Mobile machinery 58 may traverse the floor of the industrial floor 52 at a variety of speeds, and there may be specific procedures to be followed when entering or crossing the right-of-way 60. These procedures may include a limited speed, a requirement to provide an audible alert (e.g. activation of a horn) within a threshold distance of the right of way 60, a requirement to cross the right of way 60 at approximately right angles, and other such safety requirements.

Cameras 62 may be deployed within the industrial environment 50 so that the field of view of each camera 62 is such that an overlaying of the captured fields of view will result in full coverage of the floor of industrial floor 52. As noted above, in many environments, cameras 62 may be deployed for other purposes.

To obtain analysis of the video streams of cameras 62 to provide collision detection alerts that may, for example, be used to identify close proximity situations, and to provide alerts in advance of these collisions, a computer vision based system 72 such as that shown in FIG. 2 may be employed. FIG. 2 illustrates a set of functional blocks each with an input and an output. These blocks may be implemented on computing platforms, either independently or in conjunction with each other. In some embodiments, they may be implemented on a mix of edge computing elements and cloud computing resources. Through the use of computing techniques such as the instantiation of virtual computing entities (e.g. virtual machines, or containers) upon physical computing and storage resources, these virtual entities may for all purposes be explained using language that refers to each of them as an independently configured and deployed computing platform. It should be understood that such a description is not intended to be limiting in scope, and instead is used only for the purposes of a simplified description. It should be understood that each of these functions may be implemented on independent physical hardware platforms, they may be implemented as virtual entities on a common set of hardware and storage resources, or some mix of the above.

The computer based vision system 72 uses camera 62 as an input device. Camera 62 captures a series of images representative of the placement of different elements within the industrial environment 50. Each captured image forms a portion of a video stream 64 that has characteristics including a typically fixed resolution and a frame rate that indicates the number of still images captured per second. Each of these frames contains information about objects, including mobile machinery, humans and infrastructure elements, and the positioning of each of these objects with respect to each other. The constituent frames of video stream 64 may be passed to an object detection function 66. One such object detection function may be a conventional computer vision transformer such as one using the well-known You Only Look Once (YOLO) algorithm. This computer vision function analyzes each frame from the video stream 64 to identify objects and to provide bounding boxes around the identified objects. This may be provided as metadata associated with the video stream 64, and can be provided to a distance estimation function 68. The distance estimation function 68 uses known characteristics of the video stream 64, or the identified objects within the video stream, to determine the relative placement of identified objects. A monocular or stereo distance estimation function can use information about objects, for example an a priori known height of an object to determine the placement of objects with respect to each other based on a measured height in pixels. For example, if an element of mobile machinery 58 has a known height, and the identified object corresponding to the mobile machinery 58 within video stream 64 has a height in pixels, that ratio of heights can be used to determine a distance estimate to the camera 62. A similar computation for another identified object can determine a similar distance estimate to the camera 62. These distance estimates can be used by the close proximity detection function 70 to determine when two identified objects are within a defined threshold distance of each other.

The threshold distance, as noted above, may be a function of any one of a measured characteristic of the objects (e.g. the speed of mobile machinery 58), an inherent characteristic of the object (e.g. the type of mobile machinery 58), as well as characteristics of the pair of identified objects (e.g. the movement of mobile machinery 58 towards a human 56 may have a different threshold depending on whether the two identified objects are moving towards each other or away from each other as one of them indicates that the human 56 can see the mobile machinery, both of these may vary from a mobile machinery 58 approaching infrastructure 54).

Each of the above described computer vision processes can be carried out in conventional computing hardware. Many of the implementations of the functions may be improved through the use of specific processor types. For example, Graphics Processing Units (GPUs), Neural Processing Units (NPUs), and other Accelerated Processing Units (APUs) may allow for a more efficient processing for each of these functions. This may result in diminished use of the more general Central Processing Unit (CPU). This may be a more efficient implementation for each of the corresponding computer vision processes, but depending upon both the resolution and frame rate of the video stream 64, as well as the number of cameras 62 that each generate a video stream 64, the GPU, NPU and APU resources may become constrained leading to bottlenecks in the processing of the video streams, while CPU resources remain unused.

Because each video stream has characteristics, e.g. frame rate and resolution, that directly relate to the processing load of computer vision system 72, one possible solution is to reduce at least one of the frame rates and the resolution of the video stream. Reduction of the resolution is possible, but it may have adverse results as finer details in the image may be lost. If different elements of mobile machinery 58 have both identifiers and characteristics that vary based on the identifier, a reduction in the resolution may result in an inability to properly assess and identify the object. Reducing the frame rate of the video stream 64 reduces the ability to detect objects getting too close to each other with the same degree of accuracy as is provided by the original frame rate. This typically requires an adjustment of the threshold distances that are acceptable before an alert or other warning or instruction are issued. Furthermore, many video cameras will generate video streams with a frame rate of 24 or 30 frames per second. This provides a very limited range of adjustment.

While using CPU resources may not be ideal for each of the implemented functions, it would be desirable to reduce the utilization of the more specialized computing resources if this can be done without compromising the accuracy of the computer vision processing system 72.

It would therefore be beneficial to have a system that can detect mobile or moving objects approaching another object, that reduces the computing load required to identify objects in close proximity.

### SUMMARY

It is an object of the aspects of the present disclosure to obviate or mitigate the problems of the above-discussed prior art.

In accordance with a first aspect, there is provided a proximity detection system for detecting close proximity of two objects identified in a video stream, the system comprising: a background subtraction subsystem for receiving the video stream, having objects in a foreground and objects in a background, from a camera and for generating information corresponding to an object in the foreground of the video stream moving with respect to the background of the video stream; an object classifier for classifying the object associated with the generated information by type of object; an object detection subsystem for receiving the generated information corresponding to the object, the classification of the object and the video stream, and for detecting objects in the video stream in accordance with the received generated information and classification; a distance estimation subsystem for generating positioning information associated with objects detected in the video stream; and a close proximity detection subsystem for detecting, in accordance with the generated positioning information, two detected objects being within a threshold distance of each other.

In some embodiments, the background subtraction subsystem and the object detection subsystem are each configured to receive the video stream from a camera.

In some embodiments, the background subtraction subsystem is configured to generate a mask corresponding to foreground objects in the video stream.

In some embodiments, the system further comprises an object mobility detection subsystem for identifying an object detected by the object classifier in motion, and for generating motion information associated with the identified object, and for providing the generated motion information to the object detection subsystem.

In some embodiments, the object detection subsystem is configured to detect objects in the video stream in accordance with the generated motion information received from the object mobility detection subsystem.

In some embodiments, the object detection subsystem is a computer vision based subsystem.

In some embodiments, the object detection subsystem executes an object detection algorithm to detect object within the video stream.

In some embodiments, the object detection algorithm is selected from the group consisting of: You Only Look Once (YOLO), Region based Convolutional Neural Networks (R-CNN), Faster R-CNN, Mobilenet SSD, the DETR model, or a generative artificial intelligence model.

In some embodiments, the distance estimation subsystem generates positioning information in accordance with depth estimates generated through one of: monocular or binocular depth estimation, sensor fusion with LIDAR, sensor fusion with RADAR, and time of flight data.

In some embodiments, the close proximity detection subsystem is further configured to trigger another event or generate an audible alert in response to two detected objects being within a threshold distance of each other.

In some embodiments, the close proximity detection subsystem is further configured to transmit a notification of the two detected objects being within a threshold distance of each other to one or more monitoring systems.

In some embodiments, the threshold distance is a function of a classification associated with each of the two detected objects.

In some embodiments, the threshold distance is a function of the relative speed of the two detected objects with respect to each other.

In accordance with another aspect, there is provided a method of processing video data, the method comprising: receiving the video data as a video stream from a camera; performing background subtraction on the received video stream to identify foreground objects moving relative to a background of the video stream; generating a classification associated with each identified foreground object in accordance with a predefined set of classifications; performing object detection on the video stream in accordance with information representative of the identified foreground objects and the corresponding generated classification; generating positioning information for detected objects; and detecting when two objects are determined, in accordance with the generated positioning information, to be within a threshold distance of each other.

In some embodiments, the positioning information is determined in accordance with visual depth estimation.

In some embodiments, the identification of foreground objects is provided in the form of a mask that obscures contents of a video frame with the exception of the identified objects.

In accordance with another aspect, there is provided a non-transitory computer-readable medium comprising instructions that, when executed by one or more processors, cause the one or more processors to: receive video data as a video stream from a camera; perform background subtraction on the received video stream to identify foreground objects moving relative to a background of the video stream; generate a classification associated with each identified foreground object in accordance with a predefined set of classifications; perform object detection on the video stream in accordance with information representative of the identified foreground objects and the corresponding generated classification; generate positioning information for detected objects; and detecting when two objects, in accordance with the generated positioning information, are within a threshold distance of each other.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Embodiments of the present disclosure will now be described in further detail by way of example only with reference to the accompanying figures in which:

FIG. 1 illustrates a prior art representation of a video based proximity detection system;

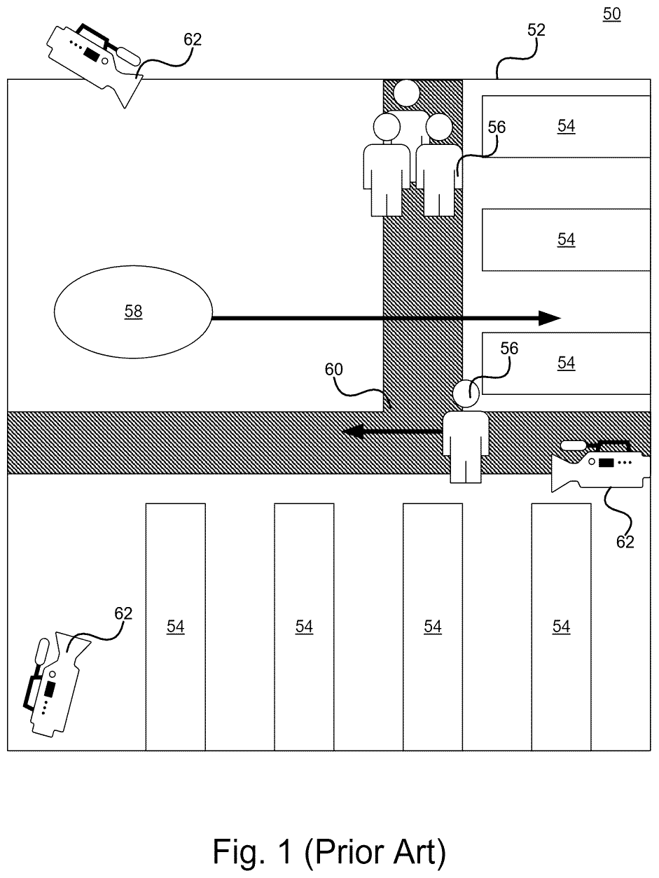

FIG. 2 is a block diagram illustrating a prior art computer vision based proximity detection system;

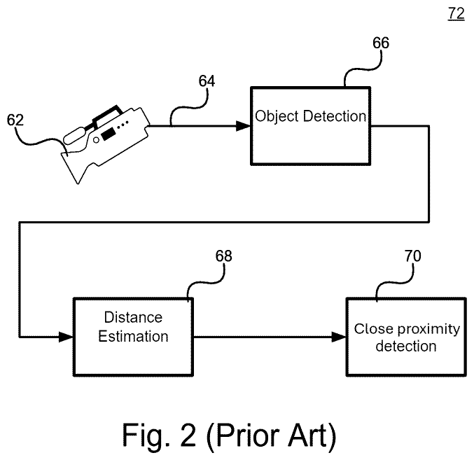

FIG. 3 is a block diagram illustrating an architecture for an artificial intelligence driven computer vision based proximity detection system;

FIG. 4A is a representation of a frame captured by a video camera for use as an input into the artificial intelligence driven proximity detection system of FIG. 3;

FIG. 4B is a representation of an output of the background subtraction subsystem illustrated in FIG. 3; and

FIG. 5 is a block diagram illustrating an implementation architecture for an embodiment.

Where possible, in the above figures, like reference numerals have been used for like elements across the figures. Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

In the instant description, and in the accompanying figures, reference to dimensions may be made. These dimensions are provided for the enablement of a single embodiment and should not be considered to be limiting or essential. Furthermore reference to particular implementations is provided without the intention that this be construed as the sole or even a preferred implementation.

As noted above, a computer vision based process to analyze captured video, identify objects of interest and determine conditions under which an alert associated with a potential collision can be implemented using accelerated processors, but the complexity of the task may saturate the processing resources requiring an increasingly large deployment of hardware and a corresponding increase in power consumption associated with processing the video feeds. As this occurs, the CPU processing resources are often underused. In the following discussion, artificial intelligence (AI) techniques will be used to reduce the complexity of the video processing. These AI techniques may increase the demand for CPU resources, but will allow for a greater reduction in the demand for GPU/NPU/APU resources. Furthermore, it will be understood that the AI techniques may employ functions embodied as transformers that are implemented as trained neural networks. The training of the neural network within a transformer may be a processor intensive task, but it is one that is only performed once and then the trained neural network can be deployed without necessarily requiring further training. This allows for an investment of power and processing cycles in advance to reduce the real-time requirements and allow for the deployed hardware to be a lightweight hardware implementation more suited to operate at a network edge.

Those skilled in the art will appreciate that the following discussion of AI-based solutions will refer to trained neural networks referred to as transformers which are designed to receive an input, and based on a trained response, will generate and provide an output. Although transformers are conventionally based on training a neural network (for example a fully or partially connected network of neural network nodes), it should be understood that other AI based techniques including rule based processing may be employed without departing from an intended scope of protection.

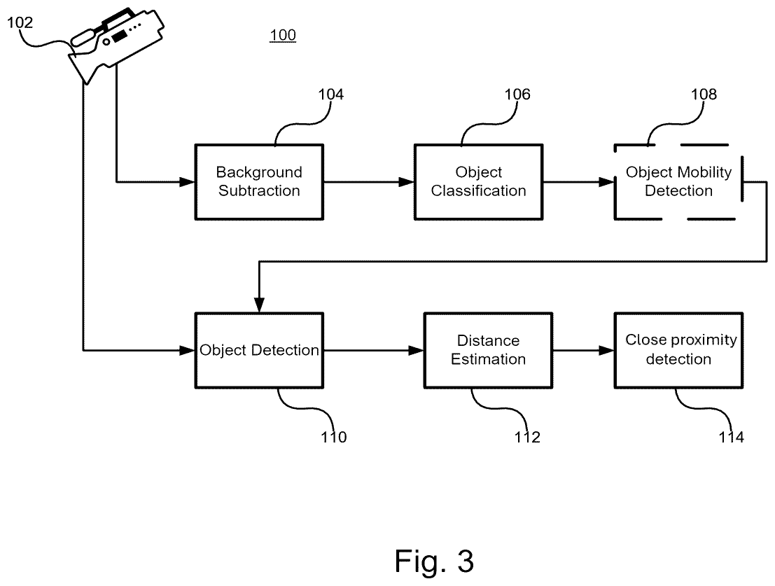

FIG. 3 illustrates an architecture for an AI driven proximity detection system 100 that receives a video stream from a camera 102 as an input. It will be appreciated that that in some embodiments, the system 100 may be used to detect close proximity between moving human workers and machinery, but also between moving human workers. In some embodiments, close proximity may also be used to detect/confirm intended close engagement between two objects, living or non-living, instead of collisions or near collisions, which may in some situations be a desired outcome, for example a waitress engaging or interacting with one or more clients. A background subtraction, or other such equivalent, subsystem 104 receives the video stream and generates a simplified equivalent to the frames in the video stream. This process allows for the identification of the elements of the video frame that are in motion. Because the purpose of the overall system 100 is to identify conditions that are associated with collisions, near-collisions or engagements, it can be understood that without objects in motion, collisions/engagement are not possible. Background subtraction is a technique in which frames of a video stream, for example adjacent frames in the video stream, are compared to identify differences in the frames. These differences are typically associated with objects that are in motion with respect to a static background. In a pair of adjacent video frames, an object that is in motion will be located in a different location, resulting in the newly revealed background and the object in motion itself being identified as changes between the frames. The use of additional frames will be able to provide enough information to allow for a clearer identification of the background elements and the objects in motion. It should be understood that in some video encoding systems, such as Motion Picture Expert Group (MPEG) compliant streams, objects in motion may be easily identified by an examination of i-frames that encode only the differences between a previous frame. Background Subtraction subsystem 104 is used to differentiate between objects in motion and static and non-relevant data and to generate data associated with the objects in motion. In other embodiments this may be achieved through other processes such as Foreground Subtraction to generate a mask that can be applied to frames to hide static elements, Image Segmentation and Kernel Density Estimation. In some embodiments, filtering may be applied as a part of, or in advance of, the background subtraction process to prevent the identification of objects that are not moving more than a threshold amount, or are otherwise not relevant objects. This will be discussed later, and may be achieved by adjusting parameters of a conventional filter such as a Gaussian filter. In some embodiments, the background subtraction subsystem 104 may also provide bounding boxes or a contour function along the outer edges of the resulting objects.

The output of the background subtraction subsystem 104 is provided to an object classifier 106 which can provide identification of the objects in motion identified by the background subtraction subsystem 104. This can be used to indicate objects of interest, here to be understood to encompass both mobile objects such as mobile machinery or equipment but also moving living beings like human workers or employees, so processing resources can be allocated to objects of interest instead of, for example, static objects with a limited degree of motion (for example a carousel that demonstrates rotational motion, but not linear motion that may result in a collision with other objects or engagement between objects). Among the objects classified by the object classifier 106, a subset of these objects have mobility that makes them relevant to collision alerts or engagement detection. An object Mobility Detection subsystem 108 may optionally be included in the system 100 to allow for identification of the mobile objects classified by the object classifier 106. The resulting output can be a set of objects associated with a given video frame, with positioning, mobility and identification information that is provided as an input to the object detection subsystem 110.

Object Detection subsystem 110 may make use of known object detection algorithms or techniques such as YOLO, Region-based Convolutional Neural Network (R-CNN), Faster R-CNN, Mobilenet-SSD, the DETR model, generative AI-based techniques or the like, and it receives as its input both the video stream and the output of either object classifier 106 or the optional object mobility detection subsystem 108. Object Detection subsystem 110 receives both information identifying the objects in motion and the video stream so that analysis can be performed not only on the objects in motion, but on the other objects that the objects in motion may collide/engage with.

The object detection subsystem 110 can more easily identify the objects in motion based on the information received, thus reducing the complexity of the identification process described earlier. Distance estimation subsystem 112 determines the relative distances between objects detected by subsystem 110 as described before. In some embodiments, not all objects identified by subsystem 110 have distance estimates generated by distance estimation subsystem 112. In such embodiments, if an element of mobile machinery is moving in a given direction, and there is data about the mobility direction, distance estimation can be skipped for objects outside a range of motion determined for each object in motion. This can reduce the number of objects for which distance estimation needs to occur.

As noted earlier, distance estimates can be obtained using any number of different techniques based on the resources available. Depth Estimation using known techniques such as monocular or stereo distance estimation function or other equivalent techniques can be used where a single camera is used as an input. Distance estimates could also make use of information provided by depth detection systems that make use of LiDar, Radar or other such distance ranging techniques. The use of two cameras as input can allow for a binocular depth based system given known placement of the cameras. Those skilled in the art will appreciate that the particular techniques used by the distance estimation subsystem need not be limited to the monocular depth estimation techniques discussed above.

Based on identified objects and the distance estimates for each of the objects, and with optional information including mobility information such as a direction or speed of motion for the objects, the close proximity detection subsystem 114 can be used to identify possible collision/engagement conditions associated with objects in motion. This collisions/engagement can be with other objects in motion, static objects, infrastructure, people (static or in motion), or with other elements.

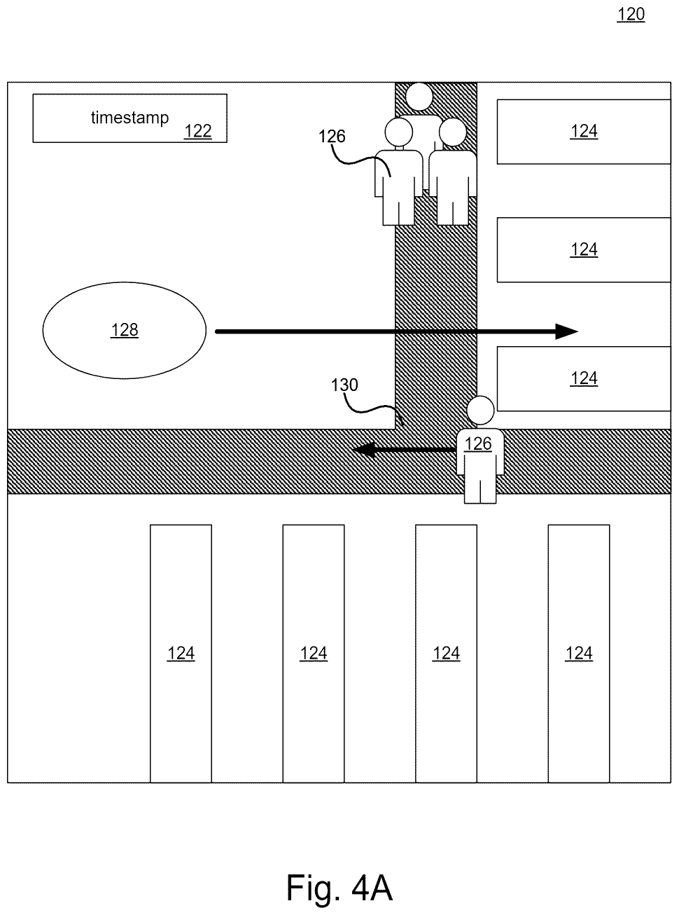

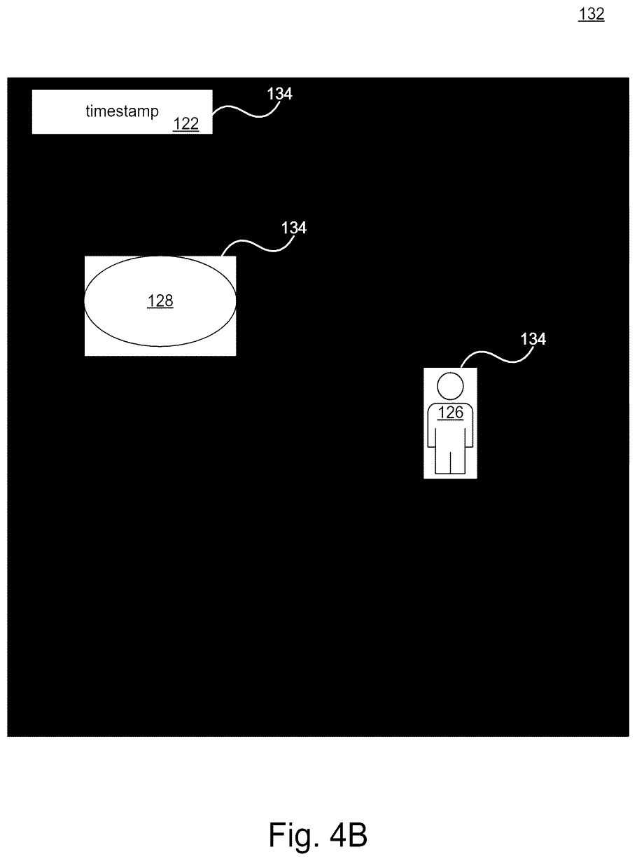

The above description of the AI driven proximity detection system 100 will serve as the basis for a further explanation with reference to FIGS. 4A and 4B. FIG. 4A illustrates a video stream 120, for example from a camera such as camera 102. Video stream 120 has a timestamp 122 that may have been added for security purposes. It should be understood that this timestamp will change over time, which may be construed as motion, but not associated with a real object. Video stream 120 also capture infrastructure elements 124 and 130, which are static elements. Humans 126 may be substantially static, such as a cluster of people who have congregated together to talk, or a human 126 may be mobile, such as when they are walking within a defined region. Mobile machinery 128 has a defined direction of motion that can be determined by comparing frames of the video stream 120 over time.

FIG. 4B illustrates a number of the effects of the AI driven transformers within AI driven proximity detection system 100. For example as a result of background subtraction subsystem 104, a frame mask 132 can be generated. Frame mask 132 is substantively the same size as a frame of stream 120, but bounding boxes 134 are present around objects within the frame that remain when frames are compared to identify objects showing either a change or specifically a change in position.

By removing objects that do not have any indication of motion, background subtraction subsystem 104 creates a simplified structure allowing for a lightweight object classifier 106 to examine the retained image portions. In some embodiments, filtering can be applied before the background subtraction process. This can sufficiently obscure the timestamp 122 so that it will not appear in the output of the background subtraction subsystem 104. In other embodiments, object classifier 106 can identify objects of interest, and in this process remove the need to further consider the timestamp 122 and other such objects. If AI driven proximity detection system 100 is concerned about detecting collisions or engagements involving mobile machinery 128, and in particular collisions caused by the mobile machinery 128, the object classifier 106 may create a tag associated with mobile machinery 128 indicating that it is classified as an object of interest. Correspondingly, human 126 may not receive this tag as there is no interest in collisions caused by the human 126 walking into objects within a frame of video stream 120.

Optional object mobility detection subsystem 108 can further identify the objects of interest (e.g., mobile objects/machinery and/or moving humans) that have an associated speed. This identification and possibly the associated speed of the object can be provided as an input to the object detection subsystem 110 as one of the two inputs. Given a possible direction of motion associated with the mobile machinery 128, the video stream 120 can be processed by subsystem 110 to identify objects that are relevant to the identified object in motion. Thus, given the data within mask 132, the processing required by subsystem 110 may be reduced to identifying object 126 and any other objects within a range of motion of the mobile machinery 126. This can create a reduced number of objects for which distance estimation is required as well.

Many of the processes undertaken in subsystems 104, 106 and 108 may make use of hardware acceleration, but they can also be largely carried out in a general purpose CPU. This helps balance the use of available resources, and by reducing the number of hardware acceleration associated tasks, the overall system can reduce the required number of dedicated GPUs/NPUs/APUs.

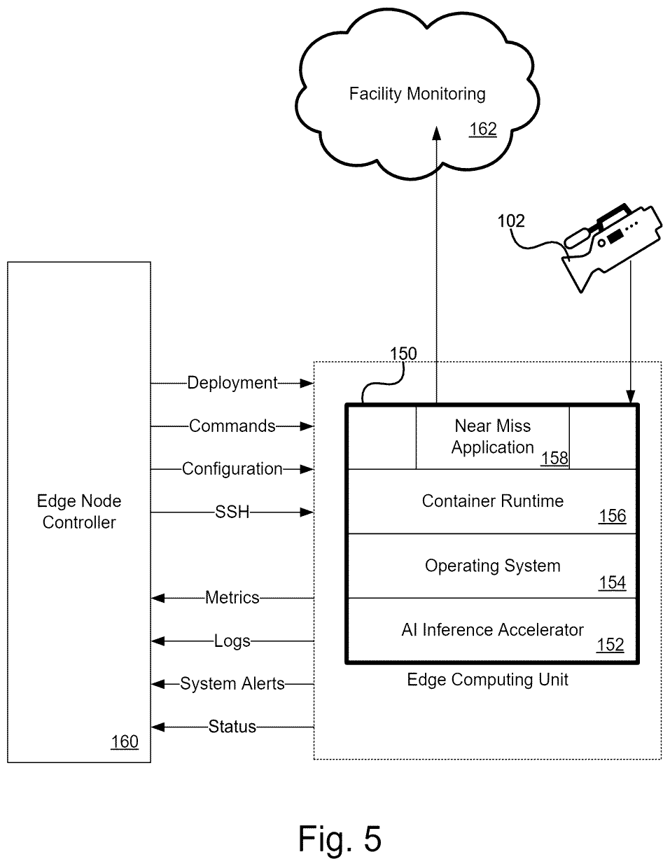

FIG. 5 illustrates an architecture for the deployment of the AI driven proximity detection system 100. The AI driven proximity detection system 100 is deployed on a series of hardware elements such as Edge Computing units 150. Edge Computing Unit 150 receives input from a camera 102, and undertakes the processing of video stream 120 as described above. Different subsystems are implemented within containers 156 instantiated upon a base operating system 154, and may make use of AI Inference accelerators 152. The Close Proximity Detection application 158 is executed on this computing platform 150 and transmits notification of near collisions or engagement between objects to a facility monitoring system 162. In some embodiments, this may include the system 100 providing a communication interface, such as an API, which can be used by the facility monitoring system 162 or other systems to receive near proximity detection information. This may be used to trigger one or more additional events in the monitoring system 162 or other systems that may benefit from having this information.

An edge node controller 160 communicates, for example via one or more networks, with the Edge Computing Unit 150 to configure and monitor the operation of the unit 150. Upon each ECU 150, multiple containers 156 can be implemented to allow for isolated processing of video streams from multiple different cameras. Furthermore, it should be understood that there can be multiple ECUs 150 deployed to a single site, allowing for a large number of video streams to be processed in real time or near real time conditions. By having a logically distinct edge node controller 160, a control plane can be created that is distinct from the data plane over which the ECU 150 receives the video stream 120 from camera 102 and over which the ECE 150 transmits alerts to the facility monitoring system 162, optionally along with video clips from video stream 120 corresponding to each alert. This differentiation between the control and data planes can allow for prioritization of one type of traffic over another, and may allow for a simplified deployment.

It will be appreciated that, in accordance with different embodiments, the system 100 and the different subsystems described above may be used in different environments. In addition to the industrial floor example discussed above, other environments may include, without limitation, consumer or commercial environments including hotels, restaurants, and stores. In these examples, the system 100 may be used specifically to detect engagement between users or individuals. Non-limiting examples include an engagement of a waitress with one or more patrons, as noted above, but more generally may include employees interacting or engaging with one or more clients. In these examples, engagement may include having the individuals in close enough proximity to interact verbally, for a given duration. This may be used, for example, to monitor an employee's performance and productivity.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

1. A proximity detection system for detecting close proximity of two objects identified in a video stream, the system comprising:
a background subtraction subsystem for receiving the video stream, having objects in a foreground and objects in a background, from a camera and for generating information corresponding to an object in the foreground of the video stream moving with respect to the background of the video stream;
an object classifier for classifying the object associated with the generated information by type of object;
an object detection subsystem for receiving the generated information corresponding to the object, the classification of the object and the video stream, and for detecting objects in the video stream in accordance with the received generated information and classification;
a distance estimation subsystem for generating positioning information associated with objects detected in the video stream; and
a close proximity detection subsystem for detecting, in accordance with the generated positioning information, two detected objects being within a threshold distance of each other.

2. The proximity detection system of claim 1 wherein the background subtraction subsystem and the object detection subsystem are each configured to receive the video stream from a camera.

3. The proximity detection system of claim 1 wherein the background subtraction subsystem is configured to generate a mask corresponding to foreground objects in the video stream.

4. The proximity detection system of claim 1 further comprising an object mobility detection subsystem for identifying an object detected by the object classifier in motion, and for generating motion information associated with the identified object, and for providing the generated motion information to the object detection subsystem.

5. The proximity detection system of claim 4 wherein the object detection subsystem is configured to detect objects in the video stream in accordance with the generated motion information received from the object mobility detection subsystem.

6. The proximity detection system of claim 1 wherein the object detection subsystem is a computer vision based subsystem.

7. The proximity detection system of claim 6 wherein the object detection subsystem executes an object detection algorithm to detect object within the video stream.

8. The proximity detection system of claim 1 wherein the object detection algorithm is selected from the group consisting of: You Only Look Once (YOLO), Region based Convolutional Neural Networks (R-CNN), Faster R-CNN, Mobilenet SSD, the DETR model, or a generative artificial intelligence model.

9. The proximity detection system of claim 1 wherein the distance estimation subsystem generates positioning information in accordance with depth estimates generated through one of: monocular or binocular depth estimation, sensor fusion with LIDAR, sensor fusion with RADAR, and time of flight data.

10. The proximity detection system of claim 1 wherein the close proximity detection subsystem is further configured to trigger another event or generate an audible alert in response to two detected objects being within a threshold distance of each other.

11. The proximity detection system of claim 1, wherein the close proximity detection subsystem is further configured to transmit a notification of the two detected objects being within a threshold distance of each other to one or more monitoring systems.

12. The proximity detection system of claim 1 wherein the threshold distance is a function of a classification associated with each of the two detected objects.

13. The proximity detection system of claim 1 wherein the threshold distance is a function of the relative speed of the two detected objects with respect to each other.

14. A method of processing video data, the method comprising:
receiving the video data as a video stream from a camera;
performing background subtraction on the received video stream to identify foreground objects moving relative to a background of the video stream;
generating a classification associated with each identified foreground object in accordance with a predefined set of classifications;
performing object detection on the video stream in accordance with information representative of the identified foreground objects and the corresponding generated classification;
generating positioning information for detected objects; and
detecting when two objects are determined, in accordance with the generated positioning information, to be within a threshold distance of each other.

15. The method of claim 14 wherein the positioning information is determined in accordance with visual depth estimation.

16. The method of claim 14 wherein the identification of foreground objects is provided in the form of a mask that obscures contents of a video frame with the exception of the identified objects.

17. A non-transitory computer-readable medium comprising instructions that, when executed by one or more processors, cause the one or more processors to:
receive video data as a video stream from a camera;
perform background subtraction on the received video stream to identify foreground objects moving relative to a background of the video stream;
generate a classification associated with each identified foreground object in accordance with a predefined set of classifications;
perform object detection on the video stream in accordance with information representative of the identified foreground objects and the corresponding generated classification;
generate positioning information for detected objects; and
detecting when two objects, in accordance with the generated positioning information, are within a threshold distance of each other.
